(19) United States
(12) Patent Application Publication
(10) Pub. No.: US 2025/0046493 A1
(43) Pub. Date: Feb. 6, 2025

(54) COMPOSITE ELECTRICAL WIRE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Keisuke KONDO, Osaka (JP); Kenji MIYAMOTO, Osaka (JP); Kazuhiro WASHIO, Osaka (JP)

(21) Appl. No.: 18/704,918

(22) PCT Filed: Oct. 13, 2022
(86) PCT No.: PCT/JP2022/038177

§ 371 Date: Apr. 26, 2024

(30) Foreign Application Priority Data
Oct. 29, 2021 (JP) 2021-177204

(51) Int. Cl. H01B 7/20; H01B 7/40

(52) U.S. Cl. CPC H01B 7/20; H01B 7/40

(57) ABSTRACT

A composite electrical wire 1 includes a shielded electrical wire 10 that includes one or more insulated electrical wires 11 and a film-like metallic shield that covers the outer periphery of the one or more insulated electrical wires 11, a lead wire 20, and a fixing member 30 that fixes the lead wire 20 to the shielded electrical wire 10. The metallic shield includes a covering part 14a that covers the outer periphery of the shielded electrical wire 10. The lead wire 20 overlaps with the covering part 14a and is electrically connected to the metallic shield. The fixing member 30 presses the mutually-overlapping covering part 14a and lead wire 20 radially inward with respect to the shielded electrical wire 10, and fixes the covering part 14a and the lead wire 20 to the shielded electrical wire 10.

### TECHNICAL FIELD

The present disclosure relates to a composite electrical wire.

### BACKGROUND

Conventionally, in general, for the purpose of noise shielding in electrical wires such as electrical wires for communication, a film-like metallic shield 94 may be arranged on the outer periphery of one or more insulated electrical wires 91 to form a shielded electrical wire 9 as illustrated in FIG. 7. An insulating sheath 95 is arranged on the outer periphery of the insulated electrical wire 91 surrounded by the metallic shield 94. At this time, in order to connect the metallic shield 94 to ground, a drain line 96 is generally arranged together with the insulated electrical wire 91 in the space surrounded by the metallic shield 94. The drain line 96 is formed as a conductor line that is not covered for insulation, and is in direct contact with the metallic shield 94 to form an electrical connection with the metallic shield 94. Due to the drain line 96 being connected to an external ground potential, the metallic shield 94 is grounded via the drain line 96.

In a shielded electrical wire that includes a metallic shield and is not provided with a drain line, as a method for grounding the metallic shield, a terminal may be directly attached to the metallic shield and connected to a ground potential. In this case, the metallic shield exposed to the outside of the electrical wire is twisted to turn from a film-like shape to a narrow linear shape, and the terminal is connected to the leading end of the linear part by crimping or the like. As another mode in which the metallic shield can be grounded without using a drain line, Patent Document 1 discloses a mode in which, in a shielded flat cable in which an electrically conductive copper foil tape is overlaid on a flat cable, an adhesive surface of the copper foil tape is adhered to an aluminum shield, and the aluminum shield is covered with a protective covering layer, the copper foil tape and the leading end of the aluminum shield are folded toward the front surface of the protective covering layer, and a lead wire is soldered to the leading end of the folded copper foil tape.

### PRIOR ART DOCUMENT

### Patent Document

Patent Document 1: JP H06-243731 A

### SUMMARY OF THE INVENTION

### Problems to be Solved

In the shielded electrical wire 9 including the film-like metallic shield 94 as illustrated in FIG. 7, in the case of arranging the insulated electrical wires 91 and the drain line 96 in the space surrounded by the metallic shield 94, the cost for providing the drain line 96 is required in the manufacture of the shielded electrical wire 9. In addition, the outer diameter of the entire shielded electrical wire 9 becomes larger due to the presence of the drain line 96. Therefore, if the drain line 96 can be omitted, it may be possible to reduce the cost for manufacturing the shielded electrical wire 9 and to reduce the diameter of the shielded electrical wire 9.

However, in the case where no drain line is provided in the shielded electrical wire, if the terminal is directly attached to the metallic shield as a means for grounding the metallic shield, the metallic shield is prone to suffer damage such as rupture or tearing at the region that extends up to the terminal and the connection part where the terminal is attached to the metallic shield by crimping or the like, because the metallic shield is a film-like member that is not high in strength. In particular, in the case of arranging the shielded electrical wire in an environment such as in a vehicle, which is susceptible to external forces from vibration or the like, there is a higher likelihood that the metallic shield will suffer such damage. In the mode disclosed in Patent Document 1, the use of a lead wire eliminates the need to use the metallic shield itself for grounding. However, it is necessary to arrange a special shield body including an electrically conductive copper foil tape with a sticky surface and an aluminum shield on the electrical wire, and this configuration cannot be easily applied to a variety of electrical wires. In addition, at the time of soldering, the constituent members of the electrical wire such as the sheath may be placed under the influence of heat, and in this respect as well, it is difficult to apply the configuration in Patent Document 1 to various electrical wires.

In view of this, an object of the present disclosure is to provide a composite electrical wire in which, in a shielded electrical wire including a film-like metallic shield, it is possible to electrically connect the metallic shield to an external potential such as a ground potential while ensuring the strength of the metallic shield against external forces without using a drain line or a special shield member.

### Means to Solve the Problem

A composite electrical wire of the present disclosure includes a shielded electrical wire including one or more insulated electrical wires and a film-like metallic shield that covers an outer periphery of the one or more insulated electrical wires, a lead wire, and a fixing member that fixes the lead wire to the shielded electrical wire, in which the metallic shield includes a covering part that covers an outer periphery of the shielded electrical wire, the lead wire overlaps with the covering part and is electrically connected to the metallic shield, and the fixing member presses the mutually-overlapping covering part and lead wire radially inward with respect to the shielded electrical wire, and fixes the covering part and the lead wire to the shielded electrical wire.

### Effect of the Invention

In the composite electrical wire according to the present disclosure, in the shielded electrical wire including the film-like metallic shield, it is possible to electrically connect the metallic shield to an external potential such as a ground potential while ensuring the strength of the metallic shield against external forces without using a drain line or a special shield member.

### BRIEF DESCRIPTION OF THE DRAWINGS

FIG. 1 is a side view of a composite electrical wire according to an embodiment of the present disclosure.

FIG. 2 is a side view from which a fixing member has been removed in FIG. 1.

FIG. 3 is a partial cross-sectional view of a longitudinal cross section (cross section taken along line A-A in FIG. 1) of the vicinity of an end portion of the composite electrical wire.

FIG. 4 is a cross-sectional view of a transverse cross section (cross section taken along line B-B in FIG. 1) of the vicinity of an end portion of the composite electrical wire.

FIG. 5 is a side view of a composite electrical wire according to a modified example of the embodiment of the present disclosure.

FIG. 6 is a cross-sectional view of a transverse cross section (cross section taken along line C-C in FIG. 5) of the vicinity of an end portion of the composite electrical wire according to the modified example.

FIG. 7 is a cross-sectional view of a conventional general shielded electrical wire including a drain line.

### DETAILED DESCRIPTION TO EXECUTE THE INVENTION

### Description of Embodiments of Present Disclosure

First, embodiments of the present disclosure will be listed and described.

(1) A composite electrical wire according the present disclosure includes a shielded electrical wire that includes one or more insulated electrical wires and a film-like metallic shield that covers an outer periphery of the one or more insulated electrical wires, a lead wire, and a fixing member that fixes the lead wire to the shielded electrical wire, in which the metallic shield includes a covering part that covers an outer periphery of the shielded electrical wire, the lead wire overlaps with the covering part and is electrically connected to the metallic shield, and the fixing member presses the mutually-overlapping covering part and lead wire radially inward with respect to the shielded electrical wire, and fixes the covering part and the lead wire to the shielded electrical wire.

In the composite electrical wire, since the lead wire is electrically connected to the metallic shield included in the shielded electrical wire and is fixed to the shielded electrical wire, the metallic shield can be connected to an external potential such as a ground potential via the lead wire without providing a drain line in the shielded electrical wire or using a special shield member. In addition, in order to fix the lead wire to the shielded electrical wire while the lead wire is electrically connected to the metallic shield, the lead wire is overlaid on the covering part provided on the metallic shield as a part covering the outer periphery of the shielded electrical wire, and the mutually-overlapping covering part and lead wire are fixed by being pressed radially inward with respect to the shielded electrical wire. Due to adopting this fixing method, the force to be applied to the metallic shield for fixing is applied from the radial outer side to the inner side of the shielded electrical wire. This force acts on the constituent members of the shielded electrical wire including an insulated electrical wire, in the direction of pressing the film surface of the metallic shield. On the other hand, this force does not act as an external force along the film surface of the metallic shield, such as tensile force, and therefore the force is unlikely to cause damage such as rupture of the metallic shield. In addition, since the covering part is maintained in the state of being retained by the fixing member, other external forces are also unlikely to be applied to the covering part. As described above, in the composite electrical wire, external forces that may cause damage to the metallic shield are unlikely to be applied to the metallic shield, and thus it is possible to sufficiently ensure the strength of the metallic shield against external forces. With regard to the covering part, covering the outer periphery of the shielded electrical wire is a concept that includes not only a mode in which a portion of the metallic shield formed by folding back the metallic shield, or the like, covers the outer periphery of the shielded electrical wire, but also a mode in which the metallic shield is exposed to the outer periphery of the shielded electrical wire, such as in the case where the metallic shield itself forms the outer periphery of the shielded electrical wire.

(2) The lead wire preferably includes an electrical wire part and a terminal attached to a conductor of the electrical wire part, the terminal preferably overlaps with the covering part and is electrically connected to the metallic shield, and the fixing member preferably presses the mutually-overlapping covering part and terminal radially inward with respect to the shielded electrical wire, and fixes the covering part and the terminal to the shielded electrical wire. Accordingly, since the lead wire is fixed by being pressed radially inward with respect to the shielded electrical wire by the fixing member at the location of the terminal, it is possible to more firmly press the lead wire against the shielded electrical wire with the fixing member and it is easier to stably maintain that state, as compared to the case where the conductor of a lead wire without a terminal is pressed against the shielded electrical wire by the fixing member.

(3) The composite electrical wire preferably further includes a cylindrical member that covers the outer periphery of the shielded electrical wire and is attached to the outer periphery of the shielded electrical wire, and the fixing member preferably sandwiches the covering part and the lead wire between the fixing member and the cylindrical member and fixes the covering part and the lead wire to the shielded electrical wire. Accordingly, the strength of the shielded electrical wire can be reinforced by the cylindrical member, and sandwiching and fixing the lead wire and the covering part between the cylindrical member and the fixing member makes it easy to achieve strong and stable fixing.

(4) The shielded electrical wire preferably further includes an insulating sheath that covers an outer periphery of the metallic shield, the metallic shield preferably has an inside part that is covered with the sheath and a folded-back part that is connected to the inside part, the folded-back part preferably forms the covering part by sandwiching the sheath between the folded-back part and the inside part and covering an outer periphery of the sheath, the lead wire preferably overlaps with the folded-back part and is electrically connected to the metallic shield, and the fixing member preferably presses the mutually-overlapping folded-back part and lead wire radially inward with respect to the shielded electrical wire, and fixes the folded-back part and the lead wire to the shielded electrical wire. In this case, the sheath insulates and protects the inside part of the metallic shield from the outside. Since the metallic shield is folded back to form the folded-back part as the covering part on the outer periphery of the sheath, it is easy to form the covering part on the metallic shield and fix the lead wire at the covering part with the fixing member. In addition, since the lead wire is fixed while being pressed inward with respect to the shielded electrical wire from the outer periphery of the whole shielded electrical wire including the sheath, it is possible to form a fixing structure that is excellent in ensuring the fixing strength and the strength of the metallic shield against external forces.

(5) In the case of (3), the shielded electrical wire preferably further includes an insulating sheath that covers an outer periphery of the metallic shield, the cylindrical member preferably covers an outer periphery of the sheath, the metallic shield preferably has an inside part that is covered with the sheath and a folded-back part that is connected to the inside part, the folded-back part preferably forms the covering part by sandwiching the sheath and the cylindrical member between the folded-back part and the inside part and covering the outer periphery of the sheath, the lead wire preferably overlaps with the folded-back part and is electrically connected to the metallic shield, and the fixing member preferably sandwiches the mutually-overlapping folded-back part and lead wire between the fixing member and the cylindrical member and fixes the folded-back part and the lead wire to the shielded electrical wire. Accordingly, it is possible to form a fixing structure that is particularly excellent in ensuring the fixing strength and the strength of the metallic shield against external forces by the effect of reinforcing the strength of the shielded electrical wire with the cylindrical member and the effect of pressing the lead wire against the inner side of the shielded electrical wire and fixing the lead wire to the shielded electrical wire from the outer periphery of the whole shielded electrical wire in which the cylindrical member is attached to the outer periphery of the sheath. This fixing structure can be easily formed by attaching the cylindrical member to the outer periphery of the sheath on the shielded electrical wire, folding back the metallic shield toward the outside of the cylindrical member to form the folded-back part, and attaching the fixing member in the state where the lead wire is overlaid on the folded-back part.

(6) The fixing member is preferably formed as a ring-shaped swaging member. This makes it easy to apply the force of pressing the covering part and the lead wire from the outer side to the inner side of the shielded electrical wire in a strong and stable manner. The fixing member can also be easily attached. In addition, even if the type and diameter of the shielded electrical wire and the shape and size of the lead wire is changed to some degree, the same fixing member can be used to fix the lead wire to the shielded electrical wire in a stable manner.

### Details of Embodiments of Present Disclosure

Hereinafter, the composite electrical wire according to an embodiment of the present disclosure will be described in detail with reference to the drawings.

### <Configuration of Composite Electrical Wire According to Embodiment>

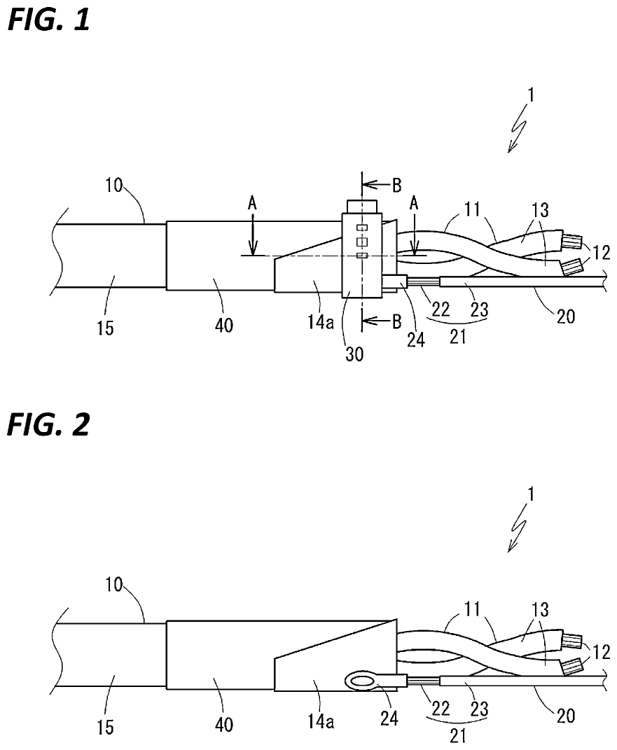

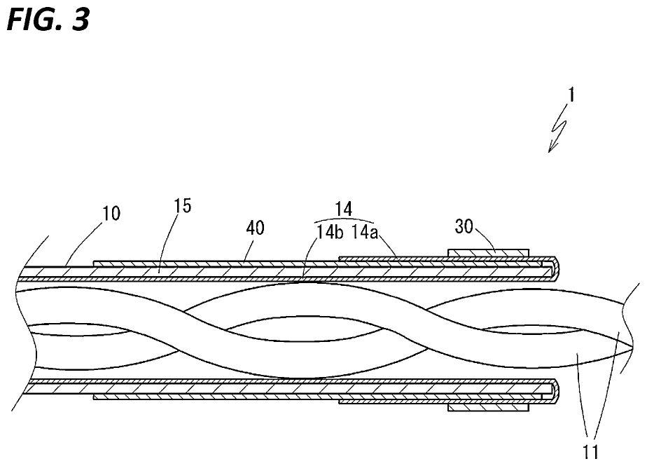

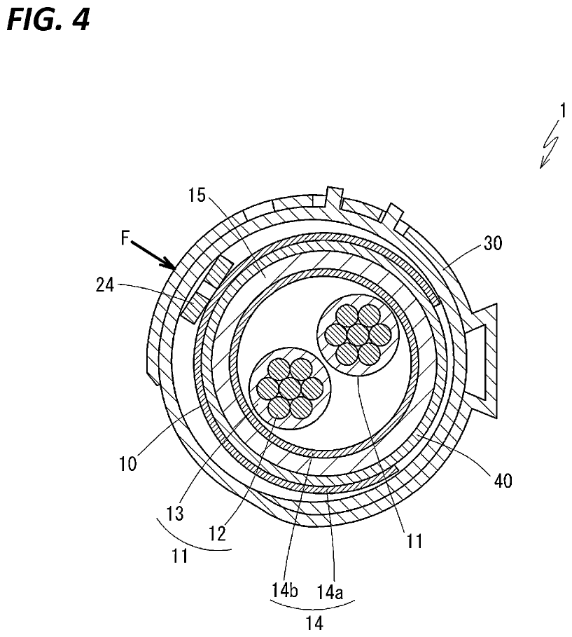

FIGS. 1 to 4 illustrate a composite electrical wire 1 according to an embodiment of the present disclosure. FIG. 1 is a side view of the composite electrical wire 1. FIG. 2 is a side view of FIG. 1 from which a fixing member 30 has been removed. FIG. 3 is a partial cross-sectional view of a longitudinal cross section (cross section taken along line A-A in FIG. 1) of the vicinity of an end portion. FIG. 4 is a cross-sectional view of a transverse cross section (cross section taken along line B-B in FIG. 1) of the vicinity of the end portion. The composite electrical wire 1 according to the present embodiment has a shielded electrical wire 10, a lead wire 20, and a fixing member 30. The lead wire 20 is fixed to the shielded electrical wire 10 by the fixing member 30 to form the composite electrical wire 1. The composite electrical wire 1 can further include a cylindrical member 40 as an auxiliary member used to fix the lead wire 20 to the shielded electrical wire 10.

The shielded electrical wire 10 has one or more insulated electrical wires 11 and a metallic shield 14 that covers the outer periphery of the one or more insulated electrical wires 11. Furthermore, an insulating sheath 15 is provided as needed, covering the outer periphery of the metallic shield 14. Each insulated electrical wire 11 is formed by covering the outer periphery of a conductor 12 with an insulating covering 13. Although the number of the insulated electrical wires 11 included in the shielded electrical wire 10 is not specified in particular, in the illustrated mode, one pair of (two) insulated electrical wires 11 are twisted to form a twist pair.

The metallic shield 14 is a film-like shield member that includes a metallic film. If a plurality of insulated electrical wires 11 are provided, the metallic shield 14 collectively surrounds the outer periphery of the core wire formed by the plurality of insulated electrical wires 11. The metallic shield 14 may be any shield with a metallic film. Although the type of metal constituting the metallic film is not limited in particular, preferred examples of the metal include aluminum, aluminum alloy, copper, and copper alloy.

The metallic shield 14 is preferably metallic foil made of a single metallic film from the viewpoint of ease of forming an electrical connection with the lead wire 20. Although the metallic foil is often low in strength, in the composite electrical wire 1 according to the present embodiment, the metallic shield 14 is less prone to undergo external forces that may cause damage such as rupture of the metallic shield 14 as described later. Alternatively, the metallic shield 14 may be made of a composite material of a metallic film and another material such as a substrate. An example of the composite material is a polymer-metal composite film in which a polymer film serving as a substrate and a metallic film are composited through evaporation, plating, adhesion, or the like. In the case of using a composite material, the metallic film may be provided on a single side or both sides of the substrate. In the case of providing the metallic film on only a single side of the substrate, the side of the metallic shield 14 with the metallic film may be faced inward or outward when arranging the metallic shield 14 on the outer periphery of the insulated electrical wires 11. However, it is necessary to set the form of a later-described folded-back part (covering part) 14a in accordance with the orientation of the metallic shield 14 such that an electrical connection can be reliably formed between the side of the metallic shield 14 with the metallic film and the lead wire 20 at the folded-back part 14a. Preferably, the metallic shield 14 is arranged on the outer periphery of the core wire formed by the insulated electrical wires 11 with the side with the metallic film facing inward, from the viewpoint of ease of forming an electrical connection with the lead wire 20 at the folded-back part 14a. In addition, the metallic shield 14 may be arranged so as to wind around the core wire formed by the twist pair of the insulated electrical wires 11 in a transverse winding form, that is, in a spiral form, or may be arranged so as to wrap the core wire in a vertically supporting form, that is, along the peripheral direction of the core wire, from the lateral side.

The sheath 15 is formed as a cylindrical member made of an insulating material, and covers the outer periphery of the metallic shield 14. Providing the sheath 15 on the shielded electrical wire 10 makes it possible to insulate the metallic shield 14 from the outside and protect the metallic shield 14 from physical stimuli such as contact with an external object.

The shielded electrical wire 10 may include constituent elements other than the insulated electrical wires 11, the metallic shield 14, and the sheath 15, but the shielded electrical wire 10 is preferably not provided with a drain line inside the space surrounded by the metallic shield 14 or between the metallic shield 14 and the sheath 15. The drain line is generally constituted by a conductor wire without an insulating covering, and can form an electrical connection by contact with the metallic shield 14. However, in the composite electrical wire 1 according to the present embodiment, the lead wire 20 that is a member separate from the shielded electrical wire 10 is electrically connected to the metallic shield 14 to electrically connect the metallic shield 14 to an external potential such as a ground potential. Thus, it is not necessary to provide a drain line for the purpose of connecting the metallic shield 14 to an external potential. Since no drain line is provided, it is possible to suppress the manufacturing cost of the shielded electrical wire 10 to a low level and ensure the small diameter of the shielded electrical wire 10. Other than the drain line, the shielded electrical wire 10 is also preferably not provided with an electrically conductive shield member that is in direct contact with the metallic shield 14, such as a metallic braided wire.

In the shielded electrical wire 10, the metallic shield 14 includes a covering part 14a. The covering part 14a is a part that is formed by a portion or all of the metallic shield 14 and covers the outer periphery of the shielded electrical wire 10. That is, in the metallic shield 14, the covering part 14a constitutes the outer periphery of the shielded electrical wire 10. The covering part 14a is integrally continuous with other parts of the metallic shield 14. In the present embodiment, the covering part 14a is located at the terminal end part of the shielded electrical wire 10 as a part of the metallic shield 14. Specifically, in the present embodiment, the metallic shield 14 has an inside part 14b covered with the sheath 15 and a folded-back part connected to the metallic shield 14b, the folded-back part being the covering part 14a. The folded-back part 14a is formed by folding back the metallic shield 14 exposed from the sheath 15 at the terminal end of the shielded electrical wire 10, toward the outside of the sheath 15 along the axial direction of the shielded electrical wire 10. The sheath 15 is sandwiched between the folded-back part 14a and the metallic shield 14b and the folded-back part 14a covers the outer periphery of the sheath 15.

Furthermore, in the illustrated mode, the cylindrical member (inner ring) 40 is attached to the outer periphery of the shielded electrical wire 10. The cylindrical member 40 is a hollow cylindrical member, preferably a circular tube-shaped member, and the shielded electrical wire 10 is press-fitted into the hollow part. The cylindrical member 40 covers the outer periphery of the sheath 15 of the shielded electrical wire 10. The metallic shield 14 is folded back toward the outside of the cylindrical member 40 to form the folded-back part 14a. That is, the covering part 14a sandwiches the sheath 15 and the cylindrical member 40 between the covering part 14a and the metallic shield 14b to cover the outer periphery of the sheath 15 and cylindrical member 40. The material for the cylindrical member 40 is not limited in particular, and any insulating material such as a resin material or any electrically conductive material such as a metal can be applied. The material strength of the cylindrical member 40 is also not limited in particular, but is preferably higher in rigidity than the sheath 15. The mode of forming the cylindrical member 40 from a metal is preferred in particular from the viewpoint of high rigidity. The cylindrical member 40 may be fixed to the sheath 15 as appropriate by an adhesive or sticky tape member, or the like.

The lead wire 20 can be made of an any electrical wire, but preferably includes an electrical wire part 21 that is made of an insulated electrical wire. At the end portion of the electrical wire part 21 that is attached to the shielded electrical wire 10, an insulating covering 23 is removed to expose a conductor 22, or a terminal 24 is attached to the conductor 22 of the electrical wire part 21. Preferably, the terminal 24 is attached to the conductor 22. The mode of attaching the terminal 24 is not limited in particular. Crimping, welding, soldering, or the like can be used, for example, but preferably, the terminal 24 is formed as a crimp terminal from the viewpoint of ease of attachment of the terminal 24. Attached to the other end (not illustrated) of the lead wire 20 is any connection member such as a ground terminal or a ground clip to make it easy to connect the lead wire 20 to an external potential such as a ground potential.

In the composite electrical wire 1, the lead wire 20 has the electrical wire part 21 extending in the direction opposite to the extending direction of the shielded electrical wire 10 and is fixed to the shielded electrical wire 10. The lead wire 20 overlaps with the covering part 14a provided on the shielded electrical wire 10 and is electrically connected to the metallic shield 14. In the illustrated mode, the terminal 24 attached to the terminal end of the lead wire 20 is in contact with and overlaps with the outer periphery of the covering part 14a, whereby it is electrically connected to the metallic shield 14. The lead wire 20 may be in direct contact with the covering part 14a as illustrated in the drawing or may overlap with the covering part 14a with another electrically conductive member such as solder in between, as long as the terminal 24 (or the conductor 22 exposed at the terminal end, which is also applied to the following description in this paragraph) overlaps with the covering part 14a and forms an electrical connection with the metallic shield 14. However, the terminal 24 of the lead wire 20 preferably is in direct contact with and overlaps with the covering part 14a from the viewpoint of simplifying the configuration of the composite electrical wire 1 and the viewpoint of eliminating the possibility that using an electrically conductive member such as solder will have an influence on the constituent members of the shielded electrical wire 10 such as the sheath 15. The terminal 24 of the lead wire 20 may overlap with the outer surface of the covering part 14a or may overlap with the inner surface of the covering part 14a. If the terminal 24 overlaps with the inner surface of the covering part 14a, the terminal 24 is arranged between the covering part 14a and the cylindrical member 40. In this case, the lead wire 20 overlaps with the covering part 14a with the electrical wire part 21 extending along the extending direction of the shielded electrical wire 10, and the electrical wire part 21 is folded back as appropriate toward the terminal end of the shielded electrical wire 10 so as to extend in a direction opposite to the extending direction of the shielded electrical wire 10. Preferably, the terminal 24 of the lead wire 20 overlaps with the outside of the covering part 14a from the viewpoint of ensuring the strength of fixing the terminal 24 by the fixing member 30 described next, and from the viewpoint of causing the electrical wire part 21 to extend to the side opposite to the shielded electrical wire 10 without placing a large load on the electrical wire part 21.

The fixing member 30 is a member that fixes the lead wire 20 to the shielded electrical wire 10. The fixing member 30 presses the mutually-overlapping covering part 14a and lead wire 20 radially inward with respect to the shielded electrical wire 10 and fixes the covering part 14a and the lead wire 20 to the shielded electrical wire 10. In the illustrated mode, the fixing member 30 presses the covering part 14a and the lead wire 20 radially inward with respect to the shielded electrical wire 10 while sandwiching the mutually-overlapping covering part 14a and lead wire 20 between the fixing member 30 and the cylindrical member 40. Pressing the covering part 14a and the lead wire 20 radially inward with respect to the shielded electrical wire 10 here means that a force F pressing the terminal 24 of the lead wire 20 and the film surface of the covering part 14a in the overlapping state against the constituent members of the shielded electrical wire 10 including at least the insulated electrical wires 11, is applied from an outer side to an inner side along the radial direction of the shielded electrical wire 10.

The type and material of the fixing member 30 are not limited in particular as long as the fixing member 30 can press the covering part 14a and the lead wire 20 radially inward with respect to the shielded electrical wire 10. However, a member suitably applicable to the fixing member 30 is a ring-shaped swaging member, that is, a member that surrounds the outer periphery of an assembly of the shielded electrical wire 10 and the lead wire 20 and can apply a force that acts from an outer side to an inner side on the assembly by tightening the assembly from an outer side to an inner side. Specific examples of the ring-shaped swaging member that is usable as the fixing member 30 include a band clamp as illustrated in the drawing, a screw clamp, an ear clamp, and a hose band. Examples of modes using members applicable to the fixing member 30 other than the ring-shaped swaging member include a mode of winding a string-shaped member or a band-shaped member and a mode of affixing an adhesive or sticky tape member.

The composite electrical wire 1 can be manufactured as described below, for example. First, in the region of the end portion of the shielded electrical wire 10, the sheath 15 is removed to expose the metallic shield 14. The length of the region from which the sheath 15 is removed along the axial direction of the shielded electrical wire 10 is basically equal to or larger than the length of the covering part 14a to be formed. Then, the shielded electrical wire 10 is press-fitted into the cylindrical member 40 from the leading end side, and the cylindrical member 40 is arranged in the region of the leading end side of the part covered with the sheath 15. At this time, the cylindrical member 40 may be fixed to the sheath 15 as appropriate using a tape member or the like. Next, the metallic shield 14 exposed at the leading end side of the sheath 15 is folded back toward the back side, and the folded-back part is arranged outside of the cylindrical member 40 to form the covering part 14a from the folded-back part. At this time, the entire region of the metallic shield 14 in the circumferential direction may be folded back to form the covering part 14a, or only a partial region of the metallic shield 14 in the circumferential direction may be folded back to form the covering part 14a as in the illustrated mode. Then, the lead wire 20 with the terminal 24 attached as appropriate to the leading end of the electrical wire part 21 is arranged such that the electrical wire part 21 extends in the direction opposite to the composite electrical wire 1, and the leading end portion of the lead wire 20 is overlaid on the outer periphery of the covering part 14a. FIG. 2 illustrates this state. Furthermore, the fixing member 30 is arranged on the outside of the location where the lead wire 20 and the covering part 14a overlap each other, and a force F that presses the mutually-overlapping lead wire 20 and covering part 14a inward with respect to the shielded electrical wire 10 is applied from the fixing member 30 through an operation of swaging through tightening or the like.

In the composite electrical wire 1 according to the present embodiment, the metallic shield 14 is provided with the covering part 14a and the lead wire 20 is overlaid on the covering part 14a to form an electrical connection between the lead wire 20 and the covering part 14a, and the covering part 14a and the lead wire 20 are fixed to the shielded electrical wire 10 by the fixing member 30 in a state in which an electrical connection is formed. Therefore, without using a drain line, the metallic shield 14 can be electrically connected via the lead wire 20 to an external potential such as a ground potential. In addition, it is possible to form electrical connection of the metallic shield 14 to an external potential by using the metallic shield 14 originally included in the shielded electrical wire 10 and the general-purpose lead wire 20, without the use of a drain line, a conducting member for connecting the metallic shield 14 to an external potential, or a special shield member such as the shield body disclosed in Patent Document 1, for example. As stated above, since there is no need to provide the shielded electrical wire 10 with a member such as a drain line for connecting the metallic shield 14 to an external potential, it is possible to suppress the manufacturing cost of the shielded electrical wire 10 and keep the outer diameter of the shielded electrical wire 10 small. In particular, ensuring the electrical connection between the metallic shield 14 and the lead wire 20 through direct contact therebetween eliminates the need to provide a member for electrical connection and enhances the effect of suppressing the cost and reducing the diameter of the shielded electrical wire 10. In addition, it is possible to eliminate the influence of heat during soldering, for example, that may be exerted on the shielded electrical wire 10 due to the introduction of a member for electrical conduction.

In addition, in the composite electrical wire 1 according to the present embodiment, although the lead wire 20 is fixed to the shielded electrical wire 10 in the state in which the lead wire 20 is electrically connected to the metallic shield 14, the mutually-overlapping covering part 14a and lead wire 20 are pressed radially inward with respect to the shielded electrical wire 10 using the fixing member 30. That is, the force F applied from the fixing member 30 to the covering part 14a acts in the direction in which the film surface of the metallic shield 14 is pressed from an inner side to an outer side, and the force F is a force of pressing the film surface of the metallic shield 14 against the shielded electrical wire 10 including the insulated electrical wires 11 that are members generally higher in rigidity than the metallic shield 14. The force F is less prone to cause damage such as rupture and tearing of the film surface of the metallic shield 14. Furthermore, since the covering part 14a is maintained in the state of being retained by the fixing member 30, the covering part 14a is less prone to lift and undergo application of external forces. For example, unlike in the conventional mode in which the metallic shield 14 is twisted in a narrow linear shape and the terminal is attached to the linear part, there is substantially no application of a force such as a tensile force that may act on the inside of the film surface of the metallic shield 14 and cause damage such as rupture of the metallic shield 14 that is a thin film body. This condition is maintained even if the composite electrical wire 1 is placed in an environment susceptible to external forces due to vibration or the like, such as in a vehicle. Therefore, the composite electrical wire 1 according to the present embodiment exhibits high strength against external forces and damage to the metallic shield 14 due to application of external forces is less likely to occur.

Fixing the lead wire 20 to the shielded electrical wire 10 using the fixing member 30 makes it possible to avoid damage to the metallic shield 14 and fix the lead wire 20 with a higher fixing force than the strength of the metallic shield 14. The strength of the metallic shield 14 here refers to the rupture strength of the metallic shield 14 when being pulled along the film surface. In particular, when the terminal 24 is attached to the lead wire 20 and the lead wire 20 is pressed together with the covering part 14a against the shielded electrical wire 10 by the fixing member 30 at the location of the terminal 24, it is possible to apply the pressing force F from the fixing member 30 to the lead wire 20 in a strong and stable manner.

Attaching the cylindrical member 40 to the outer periphery of the shielded electrical wire 10 and fixing the lead wire 20 from the outside of the cylindrical member 40 makes it possible to reinforce the strength of the shielded electrical wire 10, in particular, the strength of the sheath 15, at the fixing location. In addition, arranging the covering part 14a and the lead wire 20 on the outer periphery of the cylindrical member 40 that is smooth and highly rigid and fixing the covering part 14a and the lead wire 20 by sandwiching between the cylindrical member 40 and the fixing member 30 makes it possible to ensure a high fixing strength and stably maintain the high fixing strength and the electrical continuity between the covering part 14a and the lead wire 20. In particular, if the constituent material of the cylindrical member 40 is higher in rigidity than the sheath 15, these effects can be achieved in a high level. Sandwiching the covering part 14a and the lead wire 20 between the cylindrical member 40 and the fixing member 30, which are both highly rigid, and applying the force F of pressing the covering part 14a and the lead wire 20 inward with respect to the shielded electrical wire 10 makes it easy to ensure the high fixing strength. However, the cylindrical member 40 is not essentially provided, and if the sheath 15 has a sufficiently high rigidity in particular, the cylindrical member 40 need not be provided and the covering part 14a and the lead wire 20 may be fixed directly to the outer periphery of the shielded electrical wire 10. In this case, the covering part 14a formed by a folded-back part is directly provided on the outer periphery of the sheath 15, the covering part 14a is formed in a state in which the sheath 15 is sandwiched between the covering part 14a and the metallic shield 14b, the lead wire 20 is overlaid on the covering part 14a, and the mutually-overlapping covering part 14a and lead wire 20 are fixed by being pressed radially inward with respect to the shielded electrical wire 10 by the fixing member 30.

As described above, as the fixing member 30, a ring-shaped swaging member can be preferably applied. Such a ring-shaped swaging member made of a metallic material in particular is suitable for the fixing member 30 in terms of its ability to strongly and stably apply the force F of pressing the covering part 14a and the lead wire 20 radially inward with respect to the shielded electrical wire 10. Furthermore, the fixing member 30 of that type can also play the role of reinforcing the shielded electrical wire 10 by covering the outer periphery of the shielded electrical wire 10. The metallic material constituting the fixing member 30 can reinforce the electrical connection between the metallic shield 14 and the lead wire 20. The ring-shaped swaging member can be easily attached and is excellent in versatility because the same swaging member can be used even if the type and diameter of the shielded electrical wire 10 and the shape and size of the lead wire 20 vary to some extent.

### Examples of Modified Embodiments

The composite electrical wire according to the embodiment of the present disclosure is not specifically limited in the configuration and position of the covering part 14a and the arrangement mode of the lead wire 20, as long as the metallic shield 14 includes the covering part 14a covering the outer periphery of the shielded electrical wire 10, the lead wire 20 overlaps the covering part 14a and is electrically connected to the metallic shield 14, and the fixing member 30 presses the mutually-overlapping covering part 14a and lead wire 20 radially inward relative to the shielded electrical wire 10 to fix the covering part 14a and the lead wire 20 to the shielded electrical wire 10. As described above, the lead wire 20 may be arranged on the outer side of the covering part 14a or may be arranged on the inner side of the covering part 14a as long as the lead wire 20 can overlap with the covering part 14a. The lead wire 20 may be in direct contact with the covering part 14a to form an electrical connection or may overlap with the covering part 14a with another electrically conductive member in between. Furthermore, the terminal 24 is not necessarily required to be attached to the terminal end of the electrical wire part 21, and the conductor 22 may merely be exposed.

In the above-described embodiment, the covering part 14a is formed as a folded-back part by folding back the metallic shield 14 toward the outer side of the sheath 15. However, the covering part 14a is not limited to such a folded-back part. The covering part 14a can be configured in any mode as long as the covering part 14a is a part of the metallic shield 14 that covers the outer periphery of the shielded electrical wire 10, that is, a part of the metallic shield 14 that is exposed to the entire outer periphery of the shielded electrical wire 10. For example, the covering part 14a can be provided on the leading end side in the extending direction of the shielded electrical wire 10 relative to the edge of the sheath 15, without the metallic shield 14 being folded back.

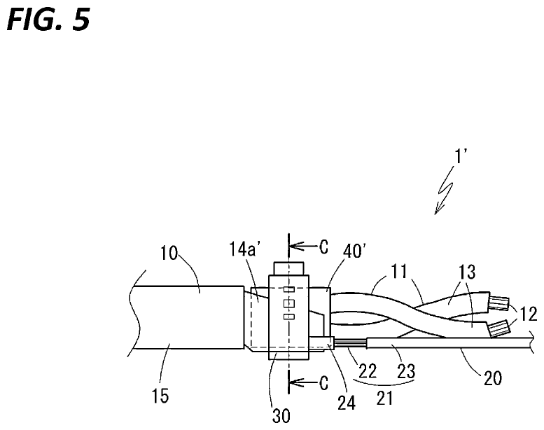

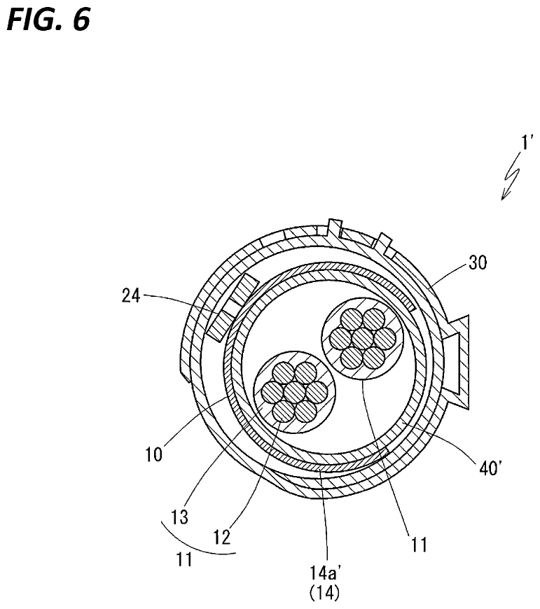

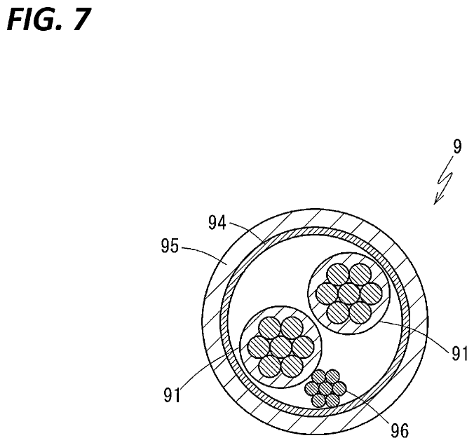

FIGS. 5 and 6 illustrate a covered electrical wire 1′ that includes a covering part 14a′ formed on the leading end side in the extending direction of a shielded electrical wire 10 relative to the edge of a sheath 15 without a metallic shield 14 being folded back. FIG. 5 is a side view, and FIG. 6 is a transverse cross-sectional view of the vicinity of the leading end portion (a cross-sectional view taken along line C-C in FIG. 5). Hereinafter, description of components that are the same as those of the composite electrical wire 1 in the embodiment described above in detail will be omitted. The corresponding members in the two modes are indicated with corresponding reference signs.

In the composite electrical wire 1′ according to the present modified example, at the leading end side of the shielded electrical wire 10, the sheath 15 is removed and the metallic shield 14 is exposed to the outer periphery of the composite electrical wire 1′. The exposed part of the metallic shield 14 constitutes the covering part 14a′ in the state of extending in the extending direction of the shielded electrical wire 10. At a position on the inner side of the covering part 14a′, a cylindrical member 40′ is fitted onto the outer periphery of the shielded electrical wire 10. That is, the cylindrical member 40′ is arranged so as to cover the outer periphery of insulated electrical wires 11, and the covering part 14a′ covers the outer periphery of the cylindrical member 40′. In FIG. 5, the part of the cylindrical member 40′ that is hidden behind the covering part 14a′ and the fixing member 30 is indicated by dotted lines.

The lead wire 20 overlaps with the outside of the covering part 14a′. The fixing member 30 is arranged on the outside of the mutually-overlapping covering part 14a′ and lead wire 20. The fixing member 30 sandwiches the covering part 14a′ and the lead wire 20 between the fixing member 30 and the cylindrical member 40′ and presses the covering part 14a′ and the lead wire 20 radially inward with respect to the shielded electrical wire 10 to fix the covering part 14a′ and the lead wire 20. In the present embodiment, the covering part 14a′ and the lead wire 20 are pressed toward the core wire made of the insulated electrical wires 11. The lead wire 20 may also be overlaid on the inside surface of the covering part 14a′. That is, the lead wire 20 may also be arranged between the cylindrical member 40′ and the covering part 14a′.

When a comparison is made between the composite electrical wire 1 with the covering part 14a serving as a folded-back part described above in detail and the composite electrical wire 1′ with the covering part 14a′ formed without folding back the metallic shield 14 according to the present modified example, the former composite electrical wire 1 is more excellent in that the material strength of the sheath 15 contributes to improvement in the fixing strength of the fixing member 30 due to the formation of the folded-back part 14a on the outer side of the sheath 15. On the other hand, the latter composite electrical wire 1′ in which the covering part 14a′ is formed without folding back is excellent in that the covering part 14a′ can be easily formed without the need to fold back the metallic shield 14 and in that the outer diameter of the part at which the lead wire 20 is to be fixed can be made smaller due to the formation of the covering part 14a′ at the position from which the sheath 15 is removed. Even if sufficient strength cannot be obtained from the shielded electrical wire 10 alone due to the absence of the sheath 15 at the position of fixing by the fixing member 30, it is possible to reinforce the strength by arranging the cylindrical member 40′ at the fixing position.

The present invention is not at all limited by the above-described embodiments, and can be improved and modified in various ways without departing from the gist of the present invention.

### LIST OF REFERENCE NUMERALS

1,1′ Composite electrical wire
10 Shielded electrical wire
11 Insulated electrical wire
12 Conductor
13 Insulating covering
14 Metallic shield
14a Covering part (folded-back part)
14a′ Covering part
14b Inside part
15 Sheath
20 Lead wire
21 Electrical wire part
22 Conductor
23 Insulating covering
24 Terminal
30 Fixing member
40, 40′ Cylindrical member
9 Shielded electrical wire
91 Insulated electrical wire
94 Metallic shield
95 Sheath
96 Drain line
F Force for pressing radially inward with respect to shielded electrical wire

1. A composite electrical wire comprising:
a shielded electrical wire that includes one or more insulated electrical wires and a film-like metallic shield that covers an outer periphery of the one or more insulated electrical wires;
a lead wire; and
a fixing member that fixes the lead wire to the shielded electrical wire,
wherein the metallic shield includes a covering part that covers an outer periphery of the shielded electrical wire,
the lead wire overlaps with the covering part and is electrically connected to the metallic shield, and
the fixing member presses the mutually-overlapping covering part and lead wire radially inward with respect to the shielded electrical wire, and fixes the covering part and the lead wire to the shielded electrical wire.

2. The composite electrical wire according to claim 1,
wherein the lead wire includes an electrical wire part and a terminal attached to a conductor of the electrical wire part,
the terminal overlaps with the covering part and is electrically connected to the metallic shield, and
the fixing member presses the mutually-overlapping covering part and terminal radially inward with respect to the shielded electrical wire, and fixes the covering part and the terminal to the shielded electrical wire.

3. The composite electrical wire according to claim 1, further comprising a cylindrical member that covers the outer periphery of the shielded electrical wire and is attached to the outer periphery of the shielded electrical wire,
wherein the fixing member sandwiches the covering part and the lead wire between the fixing member and the cylindrical member and fixes the covering part and the lead wire to the shielded electrical wire.

4. The composite electrical wire according to claim 1,
wherein the shielded electrical wire further includes an insulating sheath that covers an outer periphery of the metallic shield,
the metallic shield has an inside part that is covered with the sheath and a folded-back part that is connected to the inside part,
the folded-back part forms the covering part by sandwiching the sheath between the folded-back part and the inside part and covering an outer periphery of the sheath,
the lead wire overlaps with the folded-back part and is electrically connected to the metallic shield, and
the fixing member presses the mutually-overlapping folded-back part and lead wire radially inward with respect to the shielded electrical wire, and fixes the folded-back part and the lead wire to the shielded electrical wire.

5. The composite electrical wire according to claim 3,
wherein the shielded electrical wire further includes an insulating sheath that covers an outer periphery of the metallic shield,
the cylindrical member covers an outer periphery of the sheath,
the metallic shield has an inside part that is covered with the sheath and a folded-back part that is connected to the inside part,
the folded-back part forms the covering part by sandwiching the sheath and the cylindrical member between the folded-back part and the inside part and covering the outer periphery of the sheath,
the lead wire overlaps with the folded-back part and is electrically connected to the metallic shield, and
the fixing member sandwiches the mutually-overlapping folded-back part and lead wire between the fixing member and the cylindrical member and fixes the folded-back part and the lead wire to the shielded electrical wire.

6. The composite electrical wire according to claim 1, wherein the fixing member is formed as a ring-shaped swaging member.
